(19) United States
(12) Patent Application Publication
(10) Pub. No.: US 2020/0120937 A1
(43) Pub. Date: Apr. 23, 2020

(54) Antimicrobial Magnesium Hydroxide Nanoparticles as an Alternative to Cu Biocide for Crop Protection

(71) Applicant: University of Central Florida Research Foundation, Inc., Orlando, FL (US)

(72) Inventors: Swadeshmukul SANTRA, Oviedo, FL (US); Ziyang HUANG, Orlando, FL (US)

(21) Appl. No.: 16/659,490

(22) Filed: Oct. 21, 2019

Related U.S. Application Data
(60) Provisional application No. 62/747,937, filed on Oct. 19, 2018.

(51) Int. Cl. A01N 59/06; A01N 25/28

(52) U.S. Cl. CPC A01N 59/06; A01N 25/28

(57) ABSTRACT

In agriculture, prolonged use of Copper (Cu) biocides increases the risk of development of Cu resistance and their accumulation in soil, demanding an alternative. In this paper, we report antimicrobial Magnesium (Mg) hydroxide nanoparticles (NPs) as an alternative to Cu biocides with low cytotoxicity. To improved bioavailability, Mg hydroxide NPs were synthesized followed by coating with water-soluble capping agents, trisodium citrate (zeta potential, ξ=−22 mV) or betaine (ξ=+35 mV). Electron microscopy study confirmed the formation of ˜10 nm size cubical NPs with citrate and ˜100 nm size lamellar NPs with betaine. As-synthesized Mg hydroxide NPs inhibited bacterial growth of X. alfalfae, P. syringae and E. coli within 4 hours. Significant bacterial growth inhibition and killing were observed at 24 hours post treatment. Phytotoxicity studies on tomato plants showed no significant tissue injury. Therefore, Mg hydroxide NPs has potential to serve as Cu alternative.

### CROSS-REFERENCE TO RELATED APPLICATIONS

This application is related to U.S. Provisional Application No. 62/747,937 filed Oct. 19, 2018 to which priority is claimed under 35 USC 119. The teachings of this provisional are incorporated herein in their entirety by this reference.

### BACKGROUND

Plant diseases contribute to 10-16% of global harvest loss thus limiting food supply.¹ Viruses, bacteria, and fungi are the three major infectious factors that cause crop diseases, severely affecting food crop productivity and quality.² Copper (Cu) based bactericides/fungicides are extensively applied to control a broad spectrum of crop diseases. However, prolonged use of Cu contributes to development of Cu resistance in certain plant pathogens.^{3,4} As a result, multiple treatments are often needed to achieve proper crop protection^{5,6} Also, Cu-based disease control program experience very limited success in treating tomato bacterial spot disease due to development of resistance. Recently, United States Environmental Protection Agency (EPA) has proposed to reduce the maximum Cu annual applications rate to certain crops such as hazelnut, pecans, walnut, onion, strawberry and pepper (EPA-HQ-OPP-2010-0212). To minimize the usage of Cu products in agriculture, there is a strong need to develop Cu alternatives.

Metal oxide materials, such as Titanium Dioxide (TiO₂), Calcium Oxide (CaO), Magnesium Oxide (MgO), Copper Oxide (CuO) and Zinc Oxide (ZnO) have been extensively studied as antimicrobial agents.⁷⁻¹⁴ However, the antimicrobial properties of metal hydroxide particles have not been studied thoroughly. Low-cost and environmentally friendly magnesium hydroxide (Mg(OH)₂) has been broadly applied for acidic water neutralization, fire retardants and fertilizers.¹⁵⁻¹⁷ Mg is a plant macronutrient and particularly important for plant enzyme activation, i.e. ATPases, RNA polymerase and protein kinases.¹⁸ Mg also participates in numerous plant physiological processes such as photosynthesis and photosynthetic carbon metabolism.¹⁹ At the same time, recent studies suggest that Mg in the form of Mg(OH)₂ appears to possess antimicrobial activity at certain concentrations,^{20,21} thus positioning Mg(OH)₂ as a potential Cu alternative biocide that is made up of plant macronutrients.

### BRIEF DESCRIPTION OF DRAWINGS

FIG. 1. Overlay image of XRD patterns of (a) Commercial bulk Mg(OH)₂, (b) Mg(OH)_{2_Betaine}, (c) Mg(OH)_{2_Bare}, (d) Mg(OH)_{2_Citrate}. All the Mg(OH)₂ materials were well indexed as brucite Mg(OH)₂ (JCPDS 84-2163).

FIG. 2. Individual figures of XRD patterns of (a) Commercial bulk Mg(OH)₂, (b) Mg(OH)_{2_Betaine}, (c) Mg(OH)_{2_Bare}, (d) Mg(OH)_{2_Citrate}. The possible crystallization orientation preference was deducted by the peak intensity ratio of (001) and (101) plane.

FIG. 3. SEM image of (a) Mg(OH)_{2_Betaine}, (b) Mg(OH)_{2_Citrate}, (c) Mg(OH)_{2_Bare}.

FIG. 4. Schematic diagram of the possible mechanism of lamellar shaped Mg(OH)_{2_Betaine} forming process.

FIG. 5. HRTEM image of as-synthesized Mg(OH)₂ NPs. (a), (b) HRTEM image of Mg(OH)_{2_Citrate}, (c), (d) HRTEM image of Mg(OH)_{2_Betaine}, (e), (f) HRTEM image of Mg(OH)_{2_Bare}. The inset images at the right top (b, d, f) was the image of Inverse Fast Fourier transform (IFFT) processed from selected area.

FIG. 6. Histograms of absolute bacterial numbers of (a) E. Coli, (b) X. alfalfae, (c) P. syringae in logarithmic scale after treatment with as-synthesized Mg(OH)₂ NPs or selected controls at 4 and 24 hours time point. The concentration of betaine or citrate controls used in this experiment was at the same concentration present in the samples Mg(OH)_{2_Betaine} or Mg(OH)_{2_Citrate} at highest testing concentration. The numbers in the sample labels represent metallic Mg/Cu concentration in g/ml. “W” in the sample labels means sample was washed with DI water three times. * indicates significant difference between the sample and growth control (P<0.05)

FIG. 7. Images of tomato leaves 72 hours after application of as-synthesized Mg(OH)₂ NPs and selected controls at 1000 or 2000 μg/ml metallic Mg/Cu concentration. (a) DI water, (b) 1000 μg/ml Mg(OH)_{2_Citrate}, (c) 1000 μg/ml Mg(OH)_{2_Betaine}, (d) 1000 μg/ml Mg(OH)_{2_Bare}, (e) 1000 μg/ml KOCIDE® 3000, (f) 1000 μg/ml CuSO₄, (g) 2000 μg/ml Mg(OH)_{2_Citrate}, (h) 2000 μg/ml Mg(OH)_{2_Betaine}, (i) 2000 μg/ml Mg(OH)_{2_Bare}, (j) 2000 μg/ml KOCIDE® 3000. As synthesized Mg(OH)₂ NPs appear to have comparable phytotoxicity effect as commercial Cu control KOCIDE® 3000.

FIG. 8. Hologram showing the germination rates of tomato seeds after soaking and incubating (5 days) with as-synthesized Mg(OH)₂ NPs and selected controls. The seed germination rate is shown as mean±SD (standard deviation) of triplicate sample plates (10 tomato seeds/plate). The SD for DI water, MgCl₂ at 250 μg/ml, KOCIDE® 3000 at 16 and 250 μg/ml, Mg(OH)_{2_Citrate} at 62.5 μg/ml, Mg(OH)_{2_Betaine} at 16 and 250 μg/ml, and Mg(OH)_{2_Bare} at 16, 32 and 250 μg/ml was too small to be shown on the graph.

FIG. 9. The tomato seed root length after 5 days of soaking and incubation with as-synthesized Mg(OH)₂ NPs and selected controls. The tomato seed root length was given as mean±SD (standard deviation) of triplicate samples with 10 tomato seeds per sample. Root length for CuCl₂ treated (62.5, 125, 250 μg/ml metallic Cu concentration) tomato seeds were too short to measure (root length <1 mm). Root length graphs labeled with same alphabets are not significantly different.

FIG. 10. Histogram of hydrodynamic diameter distribution of as-synthesized Mg(OH)₂ particles in aqueous solution. (a) Mg(OH)_{2_Betaine}, (b) Mg(OH)_{2_Citrate}, (c) Mg(OH)_{2_Bare}. The average hydrodynamic diameter values were obtained from the instrument as Z-averages.

FIG. 11. FTIR spectrum of (a) trisodium citrate (black line), Mg(OH)_{2_Citrate} (red line), bulk Mg(OH)₂ (blue line); (b) betaine (black line), Mg(OH)_{2_Betaine} (red line), bulk Mg(OH)₂ (blue line).

FIG. 12. MABA assay: Bacterial viability values expressed as percentage growth compared to growth control. FIG. 12(a) E. coli, FIG. 12(b) P. syringae, FIG. 12(c) X. alfalfae. The concentration of betaine or citrate controls used in this experiment was at the same concentration present in the samples Mg(OH)_{2_Betaine} or Mg(OH)_{2_Citrate} at 2500 μg/ml metallic Magnesium concentration. The numbers in the labels represent metallic magnesium/copper concentration in g/ml. “W” in the sample labels means sample was washed with DI water for three times.

FIG. 13. Cytotoxicity assay: A549 alveolar epithelial cells viability after incubation (24 hours) with washed as-synthesized Mg(OH)₂ particles and selected controls. The numbers represent metallic magnesium concentration in g/ml. The cell viability is expressed as percentage growth compared to growth control. All as-synthesized Mg(OH)₂ particles show significant cytotoxicity only at or above 500 μg/ml concentrations of metallic magnesium (i.e. cell viability <80%).

FIG. 14. Histogram of hydrodynamic diameter distribution of as-synthesized Mg(OH)_{2_Citrate} particles in aqueous solution. Mg(OH)_{2_Citrate} (left), Mg(OH)_{2_Citrate} with H₂O₂ (center), Mg(OH)_{2_Citrate} with Zn and H₂O₂ (right), The average hydrodynamic diameter values were obtained from the instrument as Z-averages.

FIG. 15. Histogram of hydrodynamic diameter distribution of as-synthesized Mg(OH)_{2_Citrate} particles with Copper and Zinc in aqueous solution. Mg-Sol+Cu(NO₃)₂ (left), NAC-ZnO+Cu(NO₃)₂ (center), Mg-Sol+NAC-ZnO+Cu(NO₃)₂ (right), The average hydrodynamic diameter values were obtained from the instrument as Z-averages. In this figure Mg-Sol refers to Mg(OH)_{2_Citrate}.

FIG. 16. Histogram of hydrodynamic diameter distribution of as-synthesized Mg(OH)₂ particles with double coating. Mg-Sol (25% Cu) (left) and Mg-Sol+0.26 Trisodium citrate (TC)+NAC (25% Cu) (right). In this figure Mg-Sol refers to Mg(OH)₂.

FIG. 17. shows photos of treatment with KOCIDE® 3000 (top left), Mg-Sol+NAC (25% Cu²⁺) (top-right), copper nitrate (bottom left) and Mg-Sol (25% Cu²⁺) (bottom-right). In this figure Mg-Sol refers to Mg(OH)_{2_Citrate}.

Table 1. XRD data collection for as-synthesized Mg(OH)₂ particles and commercial bulk Mg(OH)₂. The possible crystallization orientation preference was deducted by the peak intensity ratio of (001) and (101) plane.

Table 2. Zeta potential values of as-synthesized Mg(OH)₂ particles at specific pH. The Zeta potential values were given as mean±SD (standard deviation) of triplicate samples.

Table 3. MIC value of as-synthesized Mg(OH)₂ NPs and selected controls. The numbers in the table represent metallic magnesium/copper concentration in g/ml. “W” in the sample labels means sample was washed with DI water for three times.

Table 4. Phytotoxicity rating scale: Tomato plants were treated with different concentrations of as-synthesized Mg(OH)₂ particles or selected controls. Phytotoxicity was rated 72 hours post treatment.

Tomato plant phytotoxicity rating on a scale of “−” non leaf damage, “+” slightly leaf damage, and “++” moderately leaf damage.

Table 5. Minimum inhibitor concentration (MIC) and Minimum Bactericidal Concentration (MBC) of P. syringae. The respective concentrations of Mg²⁺, Zn²⁺ and H₂O₂ are shown.

Table 6. Minimum inhibitor concentration (MIC) and Minimum Bactericidal Concentration (MBC) of P. syringae. The respective concentrations of Mg²⁺, Zn²⁺ and Cu²⁺ are shown.

Table 7. Zeta potential of NPs: Mg-Sol, Mg-Sol (25% Cu), and Mg-Sol (25% Cu)+0.25 TC+0.25 NAC.

Table 8. Minimum inhibitor concentration (MIC) and Minimum Bactericidal Concentration (MBC) of X. alfalfae. The respective concentrations of Mg²⁺ and Cu²⁺ are shown.

### DETAILED DESCRIPTION

Disclosed herein are Magnesium (Mg) hydroxide particles composition embodiments and method embodiments of making antimicrobial non-phytotoxic Magnesium (Mg) hydroxide particles for use as an environmentally-friendly alternative to Copper (Cu) bactericide/fungicide. Particle size varies from a few nanometer (nm, a billionth of a meter) to hundreds of nanometer. Also disclosed is a method of making charged (both positive and negative) particles using food grade chemicals. Therefore, by changing the relative percentage of oppositely charged chemicals, overall particle surface charge can be tuned from negative to null (zero) to positive. This property improves customizable rainfastness property of Mg hydroxide particles for crop protection. Mg is a plant nutrient and therefore the material is expected to improve overall plant health.

There are many ways to synthesize Mg(OH)₂, such as hydration of MgO,²² alkaline precipitation of Mg salt precursor,²³ and electrolysis of aqueous Mg salt solution.²⁴ The first two methods are heavily applied in industrial scale Mg(OH)₂ manufacturing.²⁵ In specific examples presented herein, Mg(OH)₂ NPs were synthesized through alkaline precipitation method using magnesium chloride hexahydrate (MgCl₂.6H₂O) as the Mg precursor. In addition, positively charged or negatively charged capping agents or both were used to coat the Mg(OH)₂ particles.

Xanthomonas alfalfae, Pseudomonas syringae and Escherichia coli were used for assessing the antimicrobial properties of as-synthesized Mg(OH)₂ NPs. A comprehensive set of characterization studies were performed to assess the size, particle morphology, surface charge, cytotoxicity and phytotoxicity of as-synthesized Mg(OH)₂ NPs.

According to other embodiments, Mg(OH)_{2_Citrate} NPs were synthesized in the presence of H₂O₂, and optionally in the further presence of Zinc. H₂O₂ added Mg(OH)_{2_Citrate} NPs had higher bacteriocidal efficacy compared to Mg(OH)_{2_Citrate} NPs. The Zinc added Mg(OH)_{2_Citrate} NPs further increased the bacteriocidal efficacy of the NPs.

In alternative embodiments, Mg(OH)_{2_Citrate} NPs were synthesized in the presence of a metal Cu or Zn, or both. Bacteria viability or CFU assay results suggest that Cu added Mg(OH)_{2_Citrate} exhibit similar bacteriostatic & bactericidal efficacy compare to Mg(OH)_{2_Citrate}. However, Cu added Mg(OH)_{2_Citrate} exhibit higher bactericidal efficacy (80 ppm metallic Cu) when compare with KOCIDE 3000 (320 ppm metallic Cu). The antimicrobial test result for Zn & Cu added Mg(OH)_{2_Citrate} suggest enhanced bacteriostatic & bactericidal efficacy compare Mg(OH)_{2_Citrate} and KOCIDE® 3000. and n-acetyl cysteine (NAC). In these alternative compositions, a high bactericidal efficacy is achieved with reduced amounts of copper compared to copper based bactericides like KOCIDE® 3000. The alternative embodiments can also include NPs synthesized in the presence of H₂O₂, which enables production of smaller nanoparticles.

Embodiments of NP compositions described herein can be used to treat infected plants or protect plants from infection. Plants that may be treated or protected include vegetable or crop plants, fruit plants, beverage plants, ornamental plants, nut plants, or herb/spice plants.

### Definitions

The term “plant(s)” includes the following:
Vegetable plants or crops include, for example, potatoes, preferably starch potatoes, sweet potatoes and table potatoes; root vegetables, preferably carrots, rutabaga (table beet, stubble turnips, turnips, Brassica rapa. var. rapa f. teltowiensis), scorzoneras, Jerusalem artichoke, root parsley, parsnip, radish and horseradish; tuberous vegetables, preferably kohlrabi, red beet, celeriac, radish; bulbous vegetables, preferably leeks and onions (onion sets and onions for seed production); cabbages, preferably cabbages from the Capitata group (white cabbage, red cabbage, kale, savoy cabbage), cauliflower, Brussels sprouts, broccoli, Brassica oleracea. var. sabellica, stem kale, seakale and Brassica oleracea L. convar. oleracea var. gemmifera DC.; fruiting vegetables, preferably tomatoes (field-grown tomatoes, bush tomatoes, beefsteak tomatoes, greenhouse-grown tomatoes, cocktail tomatoes, processing tomatoes and tomatoes to be sold fresh), melons, egg plants, aubergines, capsicums (bell peppers, paprika, Spanish pepper), chillis, pumpkins, zucchini and cucumbers (field-grown cucumbers, greenhouse-grown cucumbers, snake cucumbers, gherkins); vegetable legumes, preferably dwarf beans (as sword beans, beech beans, flageolet beans, butter beans; dried beans for boiling with green- and yellow-podded varieties), pole beans (as sword beans, beech beans, flageolet beans, butter beans with green-, blue- and yellow-podded varieties), faba beans (field beans, broad beans, varieties with white and black mottled flowers), peas (chickling vetches, chick peas, marrowfat peas, whole-pod peas, sugar peas, peas for shelling, varieties with light-green and dark green immature seeds) and lentils; leaf and stem vegetables, preferably Chinese cabbage, lettuce, cos lettuce, corn salad, iceberg lettuce, romaine lettuce, oak-leaf lettuce, chicory, radicchio, lollo rosso, arugula, endives, spinach, Swiss chard (leaves and stems) and parsley; other vegetables, preferably asparagus, rhubarb, chives, artichokes, mints, sunflowers, Florence fennel, dillweed, garden cress, mustard, poppies, peanuts, sesame and chicories for salad use. Crop plants also include grasses such as cereals (e.g wheat, rye, oats, rice, corn, buckwheat, and quinoa)
Fruit plants include, for example, fruits from the Rosacea family, like apple, pear, and quince; stone fruits, like apricot, cherry, plum and peach; berries, specifically bramble fruits, like blackberry, raspberry, loganberry and thimbleberry, true berries, like blueberry and cranberry, other berries, like gooseberry and mulberry; accessory fruits, like strawberry; fruits from the Cucurbitacea family, like gourds, including squash and pumpkin; melons and watermelons; citrus and other subtropical fruits, like lemon, lime, grapefruit, mandarine, clementine, tangerine, orange, avocado, guave, kumquat, logan, lychee and passion fruit; dates, figs, grapes (Vitis vinifera), olives and pomegranate; and tropical fruits, like banana, coconut, durian, eggfruit, mango, mangosteen, papaya, pineapple and tamarind.
Plants for the beverage and tobacco industry include tea varieties, coffee and cocoa varieties and tobacco.
Ornamental crops include (but are not limited to) aster, azalea, begonia, boxwood, cacti, caladium, calla, calendula, carnation, chrysanthemum, coleus, columbine, conifers, dahlia, daisy, daylily, delphinium, dianthus, Easter lily, fern, ficus, foxglove, fuchsia, gardenia, geranium, gerbera, gladioli, hibiscus, impatiens, iris, ivy, marigold, nasturtium, pansy, peony, petunia, phlox, pinks, poinsettia, rosemary, rose, rubberplant, salvia, sedum, snapdragon, verbena, vinca, wandering jew and zinnia.
Nuts include almond, Brazil nut, hazelnut, butternut, cashew, chestnut, macadamia, pecan, pistachio and walnut.
Herbs and spices include anise, balm, basil, chamomile, caraway, catnip, celery, chives, coriander, cumin, curry leaf, dandelion, dill, fennel, hyssop, mint, rue, sage, sweet bay, tarragon, thyme, wintergreen and wormwood.

The terms “protect” or “protecting” as used herein with respect to magnesium hydroxide nanoparticle containing compositions means delaying progession or reducing rate of infection on or in target plants.

The term “plant disease” is a disease caused by infection by a plant pathogen, including but not limited to bacterial, viral, fungal, nematode, phytomyxean, protozoan, algal and parasite plant pathogens.

The term “target plants” are plants to which MgOH₂ NP containing compositions (as described herein) have been applied.

The term “plant pathogen” as used herein refers to an organism that causes a plant disease or reduces the health of a plant. Examples of plant pathogens include bacteria, viruses, fungi, nematodes, phytomyxea, protozoa, algae and parasites. Typically, harmful micro-organisms are carried by biological vectors such as insects. Specific examples of plant pathogens include but are not limited those related to or cause the following plant diseases: Algal leaf spot, Alternaria, Anthracnose, Bacterial spot, Bacterial blast, Bacterial blight, Brown rots, Botrytis(gray mold), Citrus canker, Downy mildew, Early blight, Fire blight, Late blight, Melanose, Powdery mildew, Leaf curl, Leaf spots, Scab, Shot hole, and Walnut blight.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities. In a specific embodiment, the term “about” refers to an amount that is 5, 7, or 10 percent greater or lesser than the specified amount.

As used herein, a composition or combination “consisting essentially” of certain ingredients refers to a composition including those ingredients and lacking any ingredient that materially affects the basic and novel characteristics of the composition or method. The phrase “consisting essentially of” excludes from the claimed compositions and methods additional antimicrobial agents; unless such an ingredient is specifically listed after the phrase.

The term “applying,” “application,” “administering,” “administration,” and all their cognates, as used herein, refers to any method for contacting the plant with the Mg(OH)₂ NPs discussed herein.

Administration generally is achieved by application of the compounds in a vehicle compatible with the plant to be treated (i.e., a botanically compatible vehicle or carrier), such as an aqueous vehicle, to the plant or to the soil surrounding the plant or by injection into the plant. Any application means can be used, however preferred application methods include trunk injection and foliar spraying as described herein. Other methods include application to the soil surrounding the plant, by injection, soaking or spraying, so that the applied compounds can come into contact with the plant roots and can be taken up by the roots.

The term “botanically acceptable carrier/vehicle” or “botanically compatible carrier/vehicle,” as used herein, refers to any non-naturally occurring vehicle, in liquid, solid or gaseous form which is compatible with use on a living plant and is convenient to contain a substance or substances for application of the substance or substances to the plant, its leaves or root system, its seeds, the soil surrounding the plant, or for injection into the trunk, or any known method of application of a compound to a living plant, preferably a crop plant, for example a citrus tree.

Useful vehicles can include any known in the art, for example liquid vehicles, including aqueous vehicles, such as water, solid vehicles such as powders, granules or dusts, or gaseous vehicles such as air or vapor. Any vehicle which can be used with known devices for soaking, drenching, injecting into the soil or the plant, spraying, dusting, or any known method for applying a compound to a plant, is contemplated for use with embodiments of the invention. Typical carriers and vehicles contain inert ingredients such as fillers, bulking agents, buffers, solvents, preservatives, anti-caking agents, pH modifiers, surfactants, soil wetting agents, adjuvants, and the like. Suitable carriers and vehicles within this definition also can contain additional active ingredients such as plant defense inducer compounds, nutritional elements, fertilizers, pesticides, and the like.

The term “effective amount” or “therapeutically effective amount,” as used herein, means any amount of the compound or composition which serves its purpose, for example, treating plant disease, improving the ability of plants to defend against disease, reducing disease symptoms, treating HLB disease, minimizing crop yield decreases due to plant disease, improving crop productivity, and increasing crop quality.

The term “improved ability to defend against disease,” as used herein, refers to a measurable increase in plant defense against a disease. This can be measured in terms of a measurable decrease in disease symptoms, pathogen titer, or loss of crop yield and/or quality, or a measurable increase in growth, crop quantity or quality.

The term “improved crop productivity,” as used herein, refers to a measurable increase in the quantity of a crop in a plant or a population of plants, in terms of numbers, size, or weight of crop seeds, fruits, vegetable matter, fiber, grain, and the like.

The term “improved crop quality,” as used herein, refers to a measurable increase in the quality of a crop, in terms of numbers, size, or weight of crop seeds, fruits, vegetable matter, fiber, grain, and the like, or in terms of sugar content, juice content, unblemished appearance, color, or taste.

The term “improved resistance to disease,” as used herein, refers to an increase of plant defense in a healthy plant or a decrease in disease severity of a plant or a population of plants, or in the number of diseased plants in a plant population.

The term “plant disease symptoms,” as used herein, refers to any symptom of disease, including the detectable presence of a known plant pathogen, or the presence of rot, mottling, galls, discoloration such as yellowing or browning, fruit greening, stunted growth, plant death, cellular death, cell wall breakdown, the presence of spots, the presence of lesions, dieback, wilting, dwarfing, knots, and Witch's broom.

The term “population of plants,” as used herein, refers to a group of plants, all of the same species, that inhabit a particular area at the same time. Therefore, the plants in a nursery, a grove, a farm, and the like are considered a population.

The term “reduction of disease symptoms,” as used herein, refers to a measurable decrease in the number or severity of disease symptoms.

### EXAMPLES

### Example 1: Synthesis and Testing of Mg(OH)₂ NPs

### Materials and Methods

Material.

All reagents used for synthesis and studies of Mg(OH)₂ NPs were purchased from commercial vendors without any purification: magnesium chloride hexahydrate (Fisher Scientific, USA), magnesium hydroxide (Acros), sodium hydroxide (Fisher Scientific, USA), betaine anhydrous (Acros), trisodium citrate dihydrate (Trademark Nitrogen, FL, USA), KOCIDE® 3000 (Citrus Research and Education Center, Lake Alfred, Fla., USA; gift from Dr. James H. Graham), copper (II) sulfate pentahydrate (CQ Concepts, Ringwood, Ill., USA), copper (II) chloride anhydrous (Acros), deionized (DI) water (Nanopure; Barnstead model D11911), phosphate-buffered saline (PBS) (Fisher Scientific, USA), Tryptic soy broth (TSB), nutrient broth (NB) and agar for solid media preparation were purchased from Fluka (St. Louis, Mo., USA). All the bacterial strains, Xanthomonas alfalfae subsp. citrumelonis (ATCC 49120), Pseudomonas syringae pv. syringae (ATCC 19310) and Escherichia coli (ATCC 8739) were purchased from ATCC (Manassas, Va., USA). E. coli was grown in TSB, X. alfalfae and P. syringae were grown in NB. (U.S. Department of Agriculture (USDA) permits P526P-12-04060 and P526P-15-01601).

Synthesis of Mg(OH)₂ NPs.

Mg(OH)₂ NPs in solution phase was prepared by following procedure: (a) Co-precipitation of 5.016 g of MgCl₂.6H₂O, 1.46 g of betaine and 5M sodium hydroxide (NaOH) in deionized water on magnetic stirring at room temperature (hereafter referred as Mg(OH)_{2_Betaine}). (b) Co-precipitation of 5.016 g MgCl₂.6H₂O, 3.68 g of trisodium citrate dihydrate and 5M NaOH in deionized water under magnetic stirring at room temperature (hereafter referred as Mg(OH)_{2_Citrate}). (c) Co-precipitation of 5.016 g MgCl₂.6H₂O and 5M NaOH in deionized water under magnetic stirring at room temperature (hereafter named as Mg(OH)_{2_Bare}). After 24 hours of mechanical stirring at room temperature, the as-synthesized Mg(OH)₂ NPs were then washed three times with deionized water by centrifuging at 11000 rotations per minute (RPM) for 5 min to wash off extra chemicals in Eppendorf centrifuge 5810R. The pH values of all synthesized Mg(OH)₂ NPs (20000 μg/ml of metallic Mg) are around 11.

Characterization of Mg(OH)₂ NPs.

The crystal structure of as-synthesized Mg(OH)₂ NPs was identified by X-ray diffraction (PANalytical Empyrean); by applying Cu Kc radiation with wavelength equal to 1.5406 Å and two-dimensional area detector. The average crystallite size was calculated by the Ebye-Scherrer equation. The hydrodynamic size of the as-synthesized Mg(OH)₂ NPs was measured by dynamic light scattering technique (PDDLS/Cool/Batch 40T Precision Detector). The interaction between betaine or citrate with Mg(OH)₂ NPs was measured by Fourier-transform infrared spectroscopy (FTIR, Perkin Elmer Spectrum 100 Series). The surface charge of as-synthesized Mg(OH)₂ NPs were measured by ZetaPlus Zeta Potential Analyzer (Malvern Instruments). For each sample, 750 μl of undiluted solution was slowly transferred into the folded capillary zeta cell (Malvern Instruments) without any air bubbles. The morphology and size of as-synthesized Mg(OH)₂ NPs were observed through Scanning Electron Microscopy (Zeiss ULTRA-55 FEG SEM) and Transmission Electron Microscopy (FEI Tecnai F30 TEM).

Microplate Alamar Blue Assay (MABA).

To determine the minimum inhibitory concentration (MIC) of the synthesized Mg(OH)₂ NPs, a microdilution assay was performed.²⁶ The MABA assay was used as a variant of broth microdilution assay to determine the MIC considering the interference of light absorbance by test materials. Briefly, triplicates (20 l/well) of as-synthesized Mg(OH)₂ NPs and relevant controls were added to a 96 well plate. As described by clinical and laboratory standards institute (CLSI), all the tested bacterial species (180 l/well) were added such that the final concentration was 5×10⁵ CFU/ml.

In case of E. coli, the 96-well plate was incubated at 37° C. and for X. alfalfae and P. syringae, the plates were incubated at 27° C. under shaking (150 RPM). After 24 hours of incubation, 10 μl of alamar blue dye (Molecular probes, Eugene, Oreg., USA) was added to each well. The plate was then kept back in the incubator for one more hour before the absorbance was measured at both 570 and 600 nm for each well. The reduction of the dye in percentage value was calculated by using the formula as suggested by the manufacturer.

Bacterial Killing/Colony Forming Unit (CFU) Assay:

To determine the absolute values of reduction in bacterial numbers after Mg(OH)₂ NPs treatment, CFU assay was performed. The protocol used in the MABA assay was followed for this assay for treatment of bacteria with samples, but at the end of 24 hours incubation, serial dilutions of the bacteria from each well were made in respective bacterial growth media and plated on corresponding agar plates. The colonies were counted after overnight (for E. coli) and 48 hours (for X. alfalfae and P. syringae) incubation and expressed in logarithmic scale. The three concentrations of Mg(OH)₂ NPs were chosen by picking the MIC value and a dilution higher and one lower than that of MIC values derived from the MABA assay.

Cytotoxicity assay. The potential cytotoxic effects of as-synthesized Mg(OH)₂ NPs were tested against alveolar epithelial cells (A549). Various concentrations of as-synthesized Mg(OH)₂ NPs were incubated with alveolar epithelial cells in 96-well plate for 24 hours at 37° C. in the presence of 5% CO₂. After the exposure time, the cells were washed with complete fresh media [DMEM (Corning, 10-090-CV) with 10% fetal calf serum and 1% antibiotic and antimycotic]. After 3 hours incubation with 20 μl of alamar blue reagent, the contents of each well were transferred to black 96-well plate (Costar 3916, Corning life Sciences) for fluorescence (590 nm) measurement. Each concentration has three replications and the growth control was wells with only macrophages and media.

Phytotoxicity Studies.

The potential phytotoxicity of as-synthesized Mg(OH)₂ NPs and selected controls were tested on S. lycopersicum (tomato) plant (purchased from local Home Depot). Tomato plants were purchased and then placed in plant growth chamber (Panasonic MLR-352H-PA) 24 hours prior to materials spraying (programmed to simulate summer conditions, maximum temperature set at 31° C.). All as-synthesized Mg(OH)₂ NPs, DI water, CuSO₄ and KOCIDE® 3000 were foliar sprayed by using hand-operated pump mist sprayer at 1000 and 2000 μg/ml of metallic Mg or Cu. Visual observations were conducted at 24, 48 and 72 hours post-spray application.

Seed germination test. Tomato seeds (purchased from local Home Depot) were sterilized by 10% sodium hypochlorite solution for 10 min, then washed three times with DI water to ensure the removal of extra sterilizing solution remaining on the seed surface. After sterilization, all the tomato seeds were soaked in the following samples: DI water, as-synthesized Mg(OH)₂ NPs, commercial bulk Mg(OH)₂, KOCIDE® 3000, CuCl₂ or MgCl₂ at selected concentration (250, 125. 62.5, 32, 16 μg/ml of metallic Mg or Cu) for 2 hours. After soaking, the seeds were washed three times with DI water.²⁷ 5 ml of test material was added to each petri dish (85 mm diameter) with one piece of filter paper. 10 seeds were transferred onto the filter paper and each seed has at least 1 cm distance from the neighboring seed.²⁸ Three replicates of each treatment were prepared. Seeds were incubated at dark and controlled environment for six days (25° C. and 50% Relative Humidity). Seeds were considered as germinated when the coleoptiles were longer than 2 mm in length.²⁹ Seed germination rate and root length was recorded.

Statistical Analysis.

For all experiments, each treatment was conducted in triplicates, and the results were presented as mean±SD (standard deviation). The experimental data was analyzed by PASW Statistics 18 (IBM SPSS) software. Statistical data was considered significant when the experimental value compares with its corresponding control at a significance level of P less than 0.05.

### RESULTS AND DISCUSSION

Characterization of Mg(OH)₂ NPs.

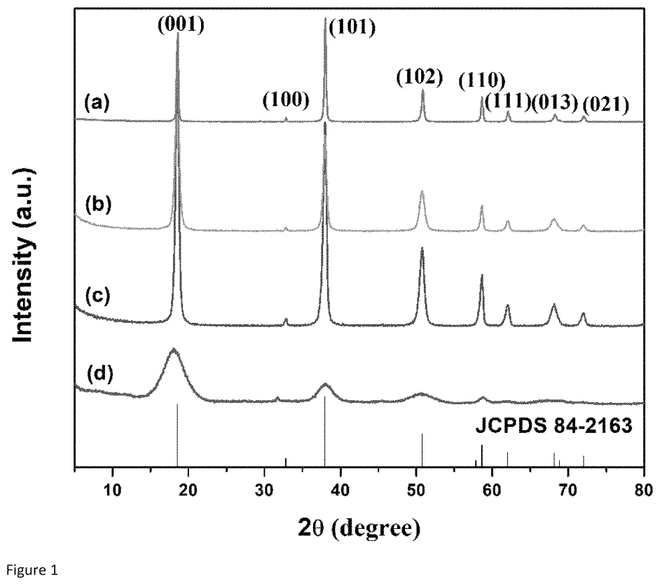

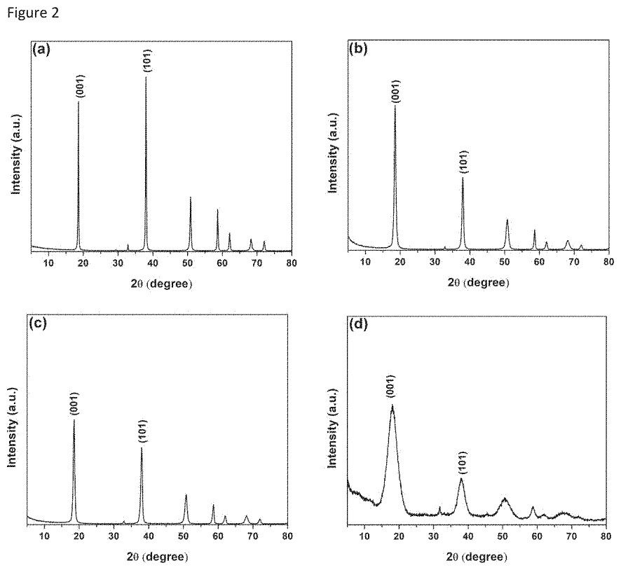

To identify the crystal structure of the as-synthesized materials, XRD technique was adopted. FIG. 1 shows the overlay X-ray diffraction pattern for (a) commercial bulk Mg(OH)₂, (b) Mg(OH)_{2_Betaine}, (c) Mg(OH)_{2_Bare} and (d) Mg(OH)_{2_Citrate}; all testing samples were well indexed as brucite Mg(OH)₂ (JCPDS 84-2163). No additional phase peak was observed in the XRD patterns, indicating pure Mg(OH)₂ was synthesized. Mg(OH)_{2_Betaine} and Mg(OH)_{2_Bare} showed strong diffraction peaks indicating good crystallinity. The peaks broadening of Mg(OH)_{2_Citrate} could be attributed to smaller grain size of Mg(OH)₂ crystals. Based on the Debye-Scherrer equation,³⁰ the estimated crystallite size for Mg(OH)_{2_Betaine}, Mg(OH)_{2_Citrate} and Mg(OH)_{2_Bare} at (001) plane direction was 18, 9, and 19 nm, respectively. The crystal structure of Mg(OH)₂ were CdI₂-type arrangement and were found to have greater preference to grow along (101) direction during crystallization process.^{31,32} According to standard XRD file, the (101) plane of Mg(OH)₂ crystal was the strongest peak in commercial Mg(OH)₂ XRD pattern (FIG. 2a). However, the XRD pattern of Mg(OH)_{2_Betaine} (FIG. 2b) and Mg(OH)_{2_Citrate} (FIG. 2d) showed unusually strong peak at (001) plane. By comparing the diffraction peak intensity ratio between (001) and (101) plane, the possible Mg(OH)₂ crystallization orientation preference can be deduced. The peak intensity value of the I₀₀₁/I₁₀₁ for bulk commercial Mg(OH)₂, Mg(OH)_{2_Betaine}, Mg(OH)_{2_Citrate} was 0.86, 1.99 and 2.59 respectively (Table 1), indicating the dominance of (001) plane for Mg(OH)_{2_Betaine} and Mg(OH)_{2_Citrate}, which could attribute to the templating effect by carboxylate group on the betaine and citrate.³³

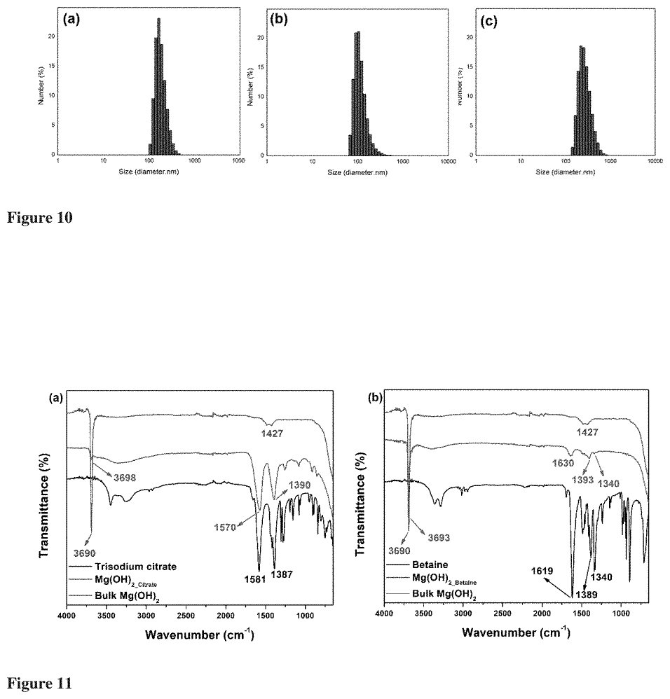

The hydrodynamic size of as-synthesized Mg(OH)₂ NPs was measured by DLS. The average size for Mg(OH)_{2_Betaine}, Mg(OH)_{2_Citrate} and Mg(OH)_{2_Bare} in aqueous solution was around 240 nm, 228 nm and 351 nm, respectively (FIG. 10). The isoelectric point of Mg(OH)₂ in water has been reported around pH 12.³⁴ In this study, Mg(OH)₂ NPs were synthesized at pH 11. According to the isoelectric point of Mg(OH)₂, the net charge of Mg(OH)₂ NPs was expected to be slightly positive, so the adsorption of betaine (through hydrophobic-hydrophobic interaction between the particle and betaine hydrophobic chain) and trisodium citrate (through deprotonated negative charged carboxyl group) onto the particle surface is favored. Therefore, Mg(OH)_{2_Betaine} will show positive surface charge (=+35 mV, pH: 10.7) because of quaternary ammonia group; whereas the deprotonated carboxyl group in the trisodium citrate will provide Mg(OH)_{2_Citrate} a negative charge (ξ=−22 mV, pH: 10.6). The zeta potential results further support this hypothesis (Table 2). The interaction between citrate or betaine with Mg(OH)₂ NPs was also measured by FTIR. The COO⁻ stretching band shifting indicating the binding of betaine or citrate on the surface of Mg(OH)₂ NPs through carboxylate group (FIG. 11).

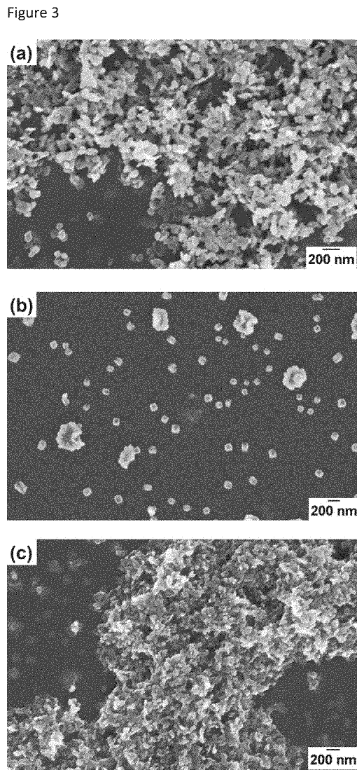

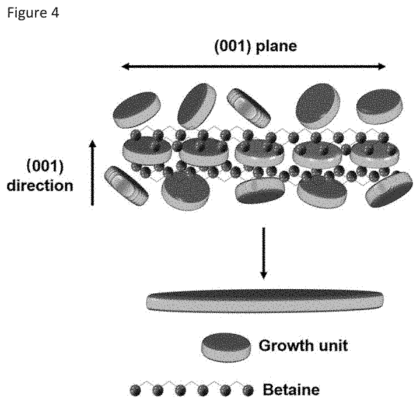

The morphology of as-synthesized Mg(OH)₂ NPs were first observed under SEM. FIG. 3a shows the Mg(OH)_{2_Betaine} were small lamellar shaped flakes and the size was around 100 nm. Betaine could be absorbed on the (001) facet of Mg(OH)₂ crystal and restricted the crystal growth along (001) direction, that might have allowed for the lamellar shaped Mg(OH)₂ particle formation. The possible Mg(OH)_{2_Betaine} formation process is showed in FIG. 4. Mg(OH)_{2_Citrate} (FIG. 3b) were cubic like structure but with similar size as Mg(OH)_{2_Betaine} where the particles were lamellar shaped. As to why they have different shapes still needs to be investigated. Mg(OH)_{2_Bare} materials (FIG. 3c) presented a gel-like structure with particles aggregating into micron size. The possible explanation could be that when the pH increases in the absence of a capping agent, fast nucleation process is the dominating factor that leads to the formation of ultra-small size sol-particles (<10 nm size). Thus, the aggregation of these particles in the form of gel is favored to lower the surface energy.³⁵ Whereas, in the presence of capping agents, electrostatic repulsion minimizes the aggregation process.

The morphology and crystallinity of as-synthesized Mg(OH)₂ NPs were further studied by HRTEM.

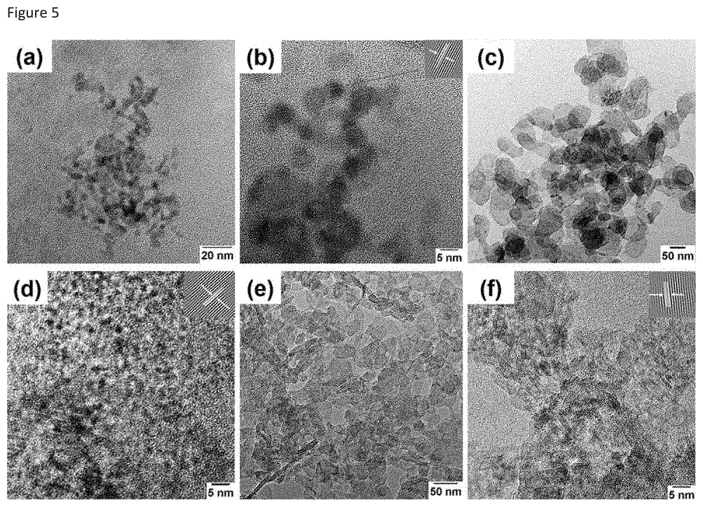

Mg(OH)_{2_Bataine} (FIG. 5c) showed similar morphological characteristics as observed under SEM (FIG. 3a). The inverse fast Fourier transform (IFFT) image of Mg(OH)_{2_Betaine} (Inset FIG. 5d) showed that the interplanar spacing was 0.16 nm, which represent the (110) plane of Mg(OH)₂ crystal. The particle size of Mg(OH)_{2_Citrate} was in the range from 5-10 nm (FIG. 5b). The IFFT image (Inset in FIG. 5b) indicated that the interplanar spacing was 0.31 nm, which could be attributed to the (100) plane of Mg(OH)₂ crystal. TEM image of Mg(OH)_{2_Bare} (FIG. 5e) illustrated a mixture of lamellar and rod-like structures. The mixture of two different shapes of Mg(OH)₂ may be due to the absence of capping agents. The IFFT image (inset in FIG. 5f) indicated the interplanar spacing was 0.20 nm, which represents the (102) plane of Mg(OH)₂ crystal.

Antimicrobial Studies:

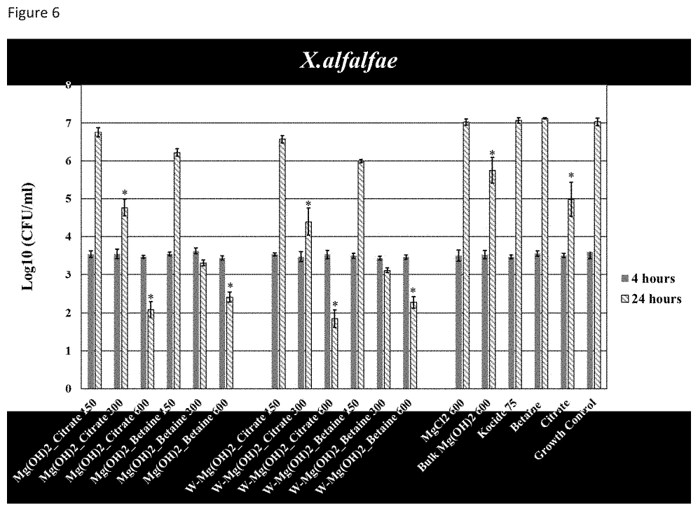

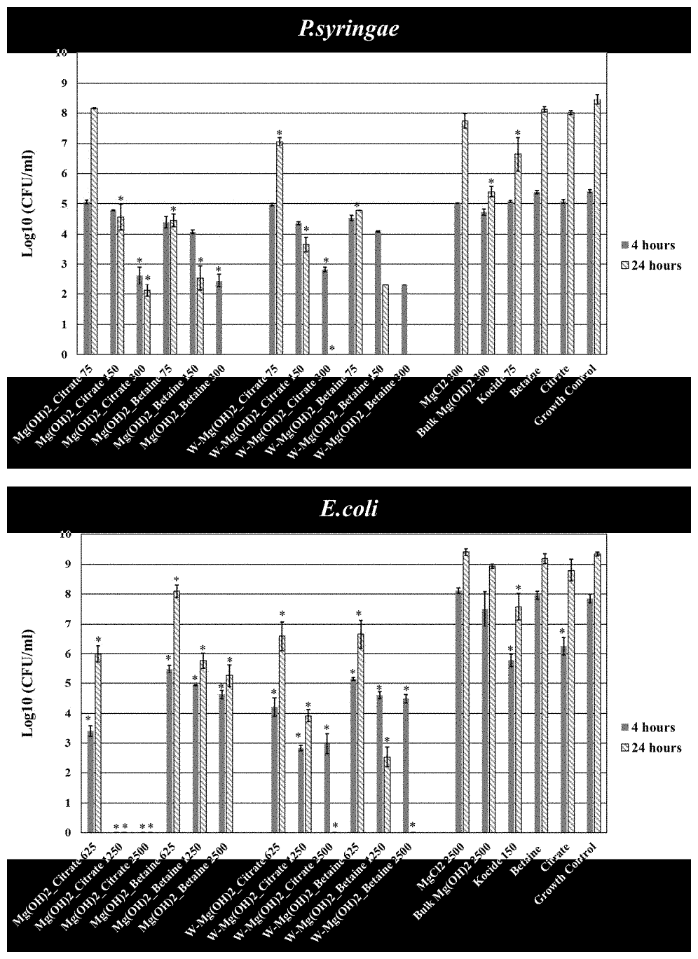

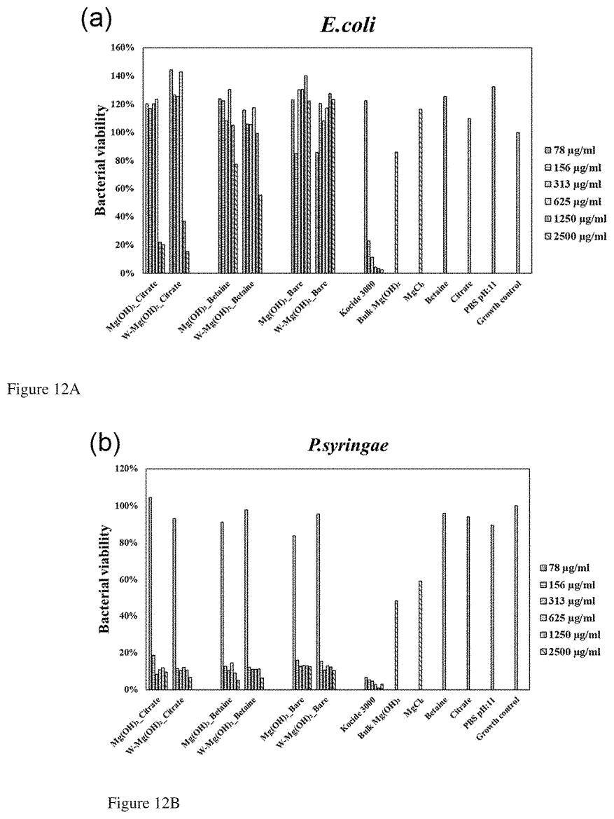

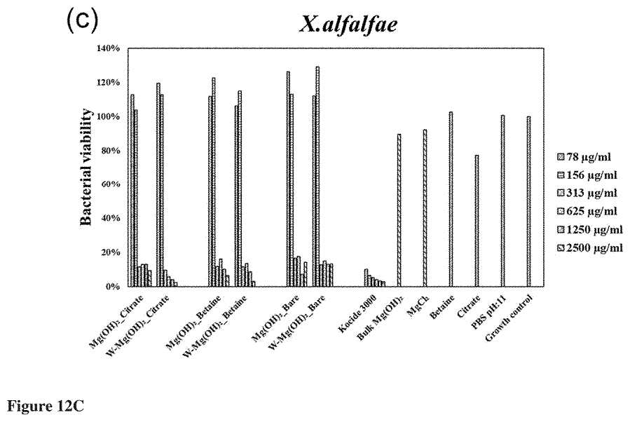

Bacterial viability or CFU assay results suggest that the as-synthesized Mg(OH)₂ NPs (at or above MIC) exhibit bacterial killing effect within the first four hours of contact with the bacteria (FIG. 6). For the CFU assay, three concentrations of Mg(OH)₂ NPs were chosen based on the MIC values as deduced from MABA assay (FIG. 12, Table 3). The synthesized Mg(OH)₂ NPs exhibit light absorbance properties thereby precluding them from using the standard MIC assay. MABA assay is a modified version of the standard MIC assay where a redox dye is used to identify and differentiate the wells containing live and/or dead bacteria. The three chosen concentrations from MABA assay included MIC value, one-fold higher and one-fold lower concentrations. At MIC values, the Mg(OH)₂ NPs exhibited 99% reduction in bacterial growth in all the three bacteria that were screened. As expected, there was no significant killing observed at the one-fold lower concentration than the MIC values for all three bacteria. Bactericidal efficacy appeared to be enhanced by the capping agents and the killing activity varied depending on the bacterial genera screened. At twice the concentrations of MIC, betaine capped Mg(OH)₂ NPs completely killed P. syringae and E. coli (except the unwashed Mg(OH)_{2_Betaine} 2500 μg/ml where there was around 4 log reduction). Whereas at twice the concentrations of MIC, citrate capped Mg(OH)₂ NPs killed E. coli and P. syringae (except the unwashed Mg(OH)_{2_Citrate} 300 μg/ml where there were around 6 log reductions in bacterial growth observed). While E. coli and P. syringae were susceptible for complete killing by Mg(OH)₂ NPs, in case of X. alfalfae, there was no complete killing observed even at the highest concentration tested (one folder higher concentration than MIC values). Nevertheless, the MIC concentrations killed >99% of X. alfalfae bacteria. Among the three bacteria that were screened, X. alfalfae, a surrogate for citrus canker bacteria, appeared to be comparatively resistant to immediate killing, as the inhibition/killing activity appeared to take effect only after 4 hours of exposure. The Mg precursor salt, MgCl₂ did not appear to have any bacterial killing effect.

Similarly, the capping agent betaine and citrate by themselves did not appear to exhibit any significant bacterial killing ability. However, the as-synthesized Mg(OH)₂ NPs with betaine or citrate capped exhibited bacterial killing activity suggesting the bacterial killing efficacy of as-synthesized Mg(OH)₂ NPs may not directly due to the capping agent. For these studies, commercially available copper bactericide (KOCIDE® 3000), a current standard for biocides in plant protection was used as a control. For all bacteria except X. alfalfae, that was screened in this experiment, KOCIDE® 3000 appeared to exhibit significant killing activity at 24 hours when used at the concentrations identified as MIC values from MABA assay. It is worthwhile to mention here that the MIC values obtained in MABA assay for X. alfalfae for KOCIDE® 3000 did not have significant levels of bacterial killing when screened by CFU assay. The inherent fluorescence of KOCIDE® 3000 could have influenced the MIC value determination in the MABA assay. Since X. alfalfae is comparatively more resistant to killing, a higher concentration of KOCIDE® 3000 could produce statistically significant bacterial growth inhibition as observed by M. Young et al.¹⁴ All the synthesized Mg(OH)₂ NPs, with both the capping agents exhibited comparable killing efficacy suggesting that these particles can be potential alternatives to copper-based biocides. A commercially available bulk Mg(OH)₂ used as control failed to exhibit similar antibacterial properties. Furthermore, the concentration of the active Mg that was required to exhibit killing effect differed with each bacterium suggesting differential surface effect and differential activity of Mg in the physiology of these bacteria. Since there was no killing observed in case of X. alfalfae at 4 hour time point, the possible mechanism of killing may not involve active cell wall lysis upon contact in that bacterium. The net positive charge of Mg(OH)_{2_Betaine} and Mg(OH)_{2_Bare} might in turn facilitate greater attachment of particles to the negatively charged cell surface of bacteria. However, the net negative charged Mg(OH)_{2_Citrate} showed similar bacterial killing efficacy as the ones with net positive charged Mg(OH)₂ NPs suggesting that surface charge of the particles has a minimal role to play in bacterial killing. Since understanding the mechanism of killing is beyond the scope of this current manuscript, we can speculate that Mg(OH)₂ NPs exhibit bacterial killing by raising the intracellular Mg concentrations.

The impact of unbound chemicals (not part of the particulate) on the bacterial killing ability was assessed by screening washed materials alongside as-synthesized unwashed materials (FIG. 6). In case of X. alfalfae, there was no significant difference observed between washed and unwashed at both 4 and 24 hours time point (FIG. 6b). In case of P. syringae, the bacterial killing was similar for both washed and unwashed samples at 4 hours time point. Whereas at 24 hours time point, the washed Mg(OH)_{2_Citrate} appears to have better bacterial killing efficacy (FIG. 6c). In case of E. coli, washing has significant effects on bacterial killing at both 4 and 24 hours. The unwashed samples appear to completely kill E. coli at and above MIC values. Whereas washing of citrate capped Mg(OH)₂ NPs reduced the killing efficacy (FIG. 6a). Thus, the unbound chemicals appear to influence the killing efficacy at varied levels across different species of bacteria.

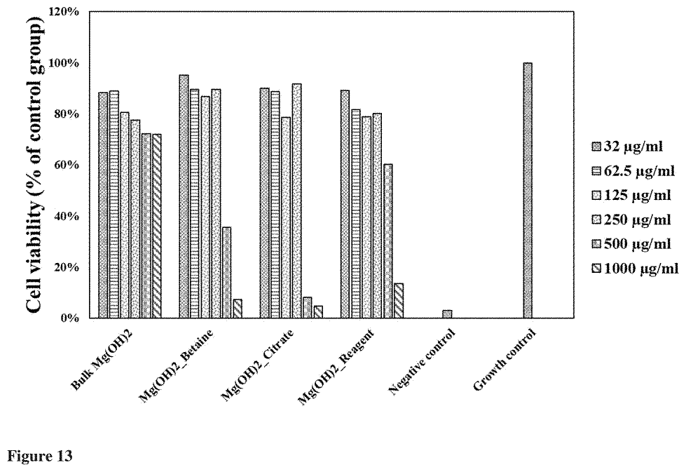

In another experiment, the effect of Mg(OH)₂ NPs on eukaryotic cell lines was tested using A549 alveolar epithelial cells (FIG. 13). All the materials appear to have significant cytotoxic effect only at or above 500 μg/ml of metallic Mg. This preliminary information will be the basis for further investigation of the as-synthesized Mg(OH)₂ NPs as potential biocides with minimal off-target effects.

Phytotoxicity Assay.

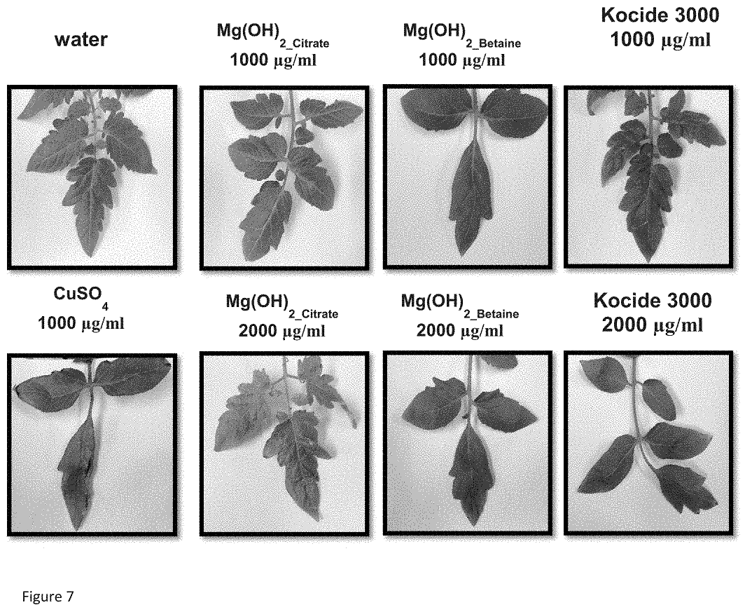

The potential plant tissue damage on the leaves of as-synthesized Mg(OH)₂ NPs with controls was tested on tomato plant through foliar spray. After three days incubation, potential phytotoxicity symptoms were evaluated by visual observation (FIG. 7). CuSO₄ (1000 μg/ml metallic Cu) treated tomato plants showed severe leaf browning and deformation. KOCIDE® 3000 showed reduced phytotoxicity compared to CuSO₄, exhibiting no damage at 1000 μg/ml and slightly leaf edge browning at 2000 μg/ml. The possible reason for the difference in phytotoxicity could be that the major active ingredient for KOCIDE® 3000 is copper hydroxide. The solubility product (Kₛₚ) for copper hydroxide is 2×10⁻⁵ moles of Cu per liter, therefore KOCIDE® 3000 has very limited Cu ions in the aqueous solution compared to water-soluble CuSO₄. Mg(OH)_{2_Betaine} and Mg(OH)_{2_Bare} exhibited no plant tissue damage at all testing concentrations except for Mg(OH)_{2_Batine} at 2000 μg/ml that showed slight leaf browning. Similar symptoms were observed for Mg(OH)_{2_Citrate} treated tomato plants (1000 and 2000 μg/ml metallic Mg). To the best of our knowledge, there are no published literatures available showing the effect of nanoparticle size on phytotoxicity of tomato leaves, where the treatment was applied by foliar method. However, there are reports on the effect of nanoparticle size on the seed germination and seedling growth. In general, smaller size particle exhibits higher level of toxicity to plant tissues in comparison to the large size particle.³⁶⁻³⁸ We also believe that smaller size particles are able to penetrate deeper in the leaf tissue, causing enhanced phytotoxicity. The detailed phytotoxicity scale rating results after three days incubation is shown in supporting information (Table 4). The concentration for phytotoxicity assays were chosen as 5 fold and 10 fold increase from MIC values to show the broader biocidal window of these new materials. In summary, all three Mg(OH)₂ NPs formulations showed great potential for application on tomato plants as the sprayed materials at concentration higher than MIC were either non or slightly toxic to tomato plant leaves.

Seed Germination Assay:

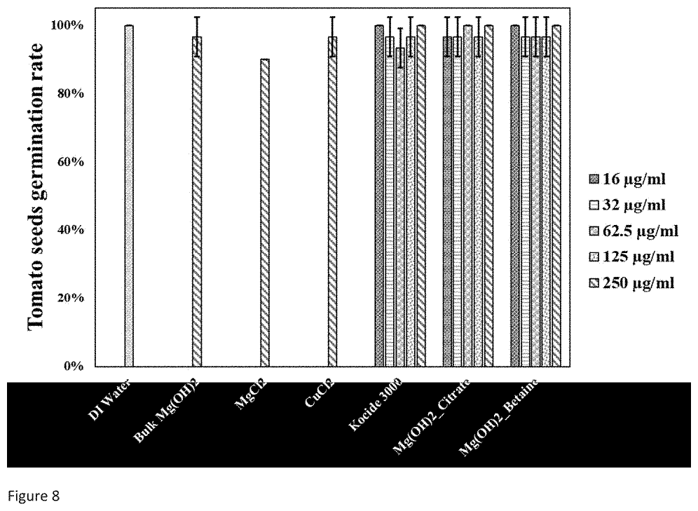

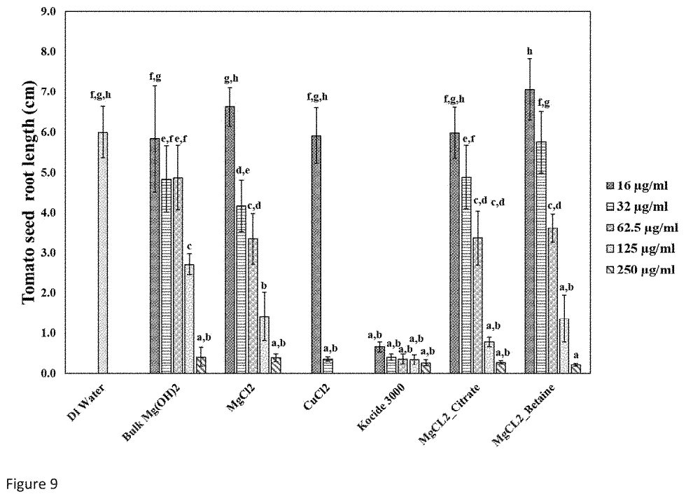

The potential phytotoxicity of as-synthesized Mg(OH)₂ NPs were further tested on tomato seed germination and root elongation. FIG. 8 shows the tomato seed germination percentage after 5 days incubation in the dark under room temperature. The results showed as-synthesized Mg(OH)₂ NPs and selected controls all have above 80% germination rate. During seed germination process, radicles emerge out of seed and come in direct contact with the testing material. Therefore, seedling root elongation process could be restricted or even terminated if there is any toxic effect from the test materials. FIG. 9 shows the tomato seed root length after 5 days incubation with as-synthesized Mg(OH)₂ NPs and selected controls. KOCIDE® 3000 shows significant inhibition on tomato root development even at the lowest concentration tested (16 μg/ml metallic Cu). All three Mg(OH)₂ NPs formulations showed dose-response relationship between root length and testing concentration; no significant root growth inhibition was observed up to 32 μg/ml metallic Mg in the test materials. Root length decreased with increasing Mg concentration. At 250 μg/ml metallic Mg, root appeared unhealthy and was dark brown in color. MgCl₂ and CuCl₂ were used as controls to test the effect of Mg and Cu ion on tomato seeds root elongation. CuCl₂ has no inhibitory effect on root elongation at 16 μg/ml metallic Cu, but root elongation was significantly retarded and even terminated when the concentration was above 16 μg/ml of metallic copper. Whereas, MgCl₂ treated tomato seed root elongation results showed no significant difference in toxicity when compared with as-synthesized Mg(OH)₂ NPs at each testing concentrations. Thus, the form of Mg may not directly influence the phytotoxicity effect.

In summary, Mg(OH)₂ NPs were synthesized with different shapes, size and surface charges using betaine or trisodium citrate as capping agents. As-synthesized Mg(OH)₂ NPs showed comparable bacterial killing efficacy and reduced phytotoxicity when compared with commercial Cu-based products. These results suggest that as-synthesized Mg(OH)₂ NPs have greater potential in crop protection as alternatives for copper-based biocides.

### Example 2: Synthesis and Testing of Mg(OH)₂ NPs Made with Hydrogen Peroxide (H₂O₂), Copper (Cu), Zinc(Zn), N-Acetylcysteine (NAC)

Formulations of Mg(OH)₂ NP were prepared. Hydrogen peroxide (H₂O₂), Copper (Cu), Zinc (Zn), N-acetylcysteine (NAC) were added during the synthesis Mg(OH)_{2_Citrate}. Antimicrobial studies were performed to test the possibility of enhanced bacteriostatic/bactericidal properties.

1. Mg(OH)_{2_Citrate} with Hydrogen Peroxide (H₂O₂)

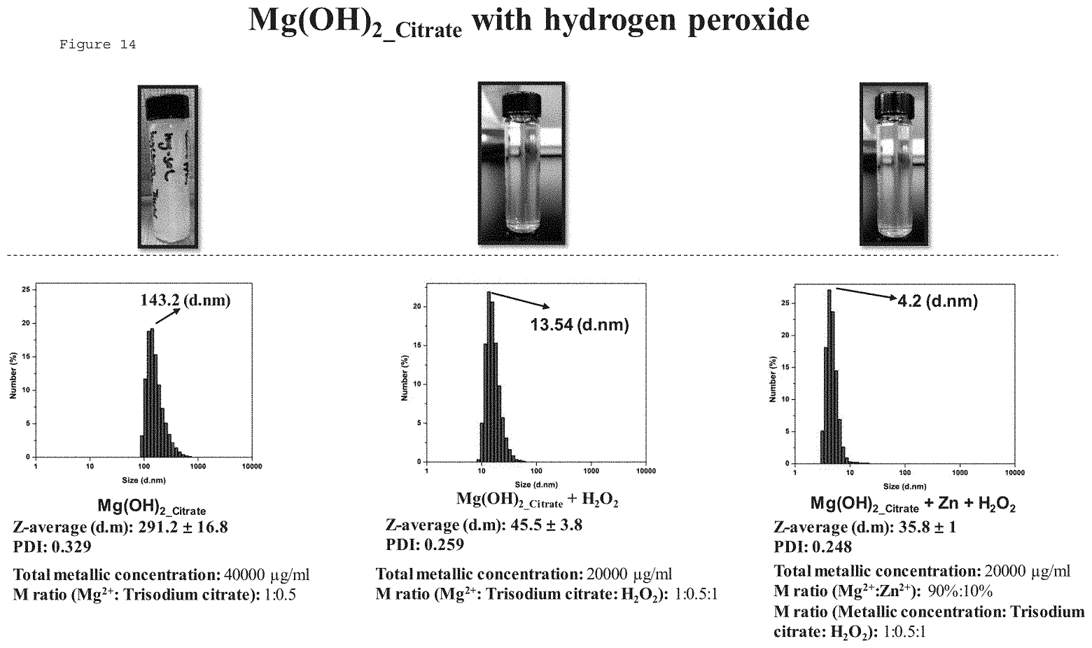

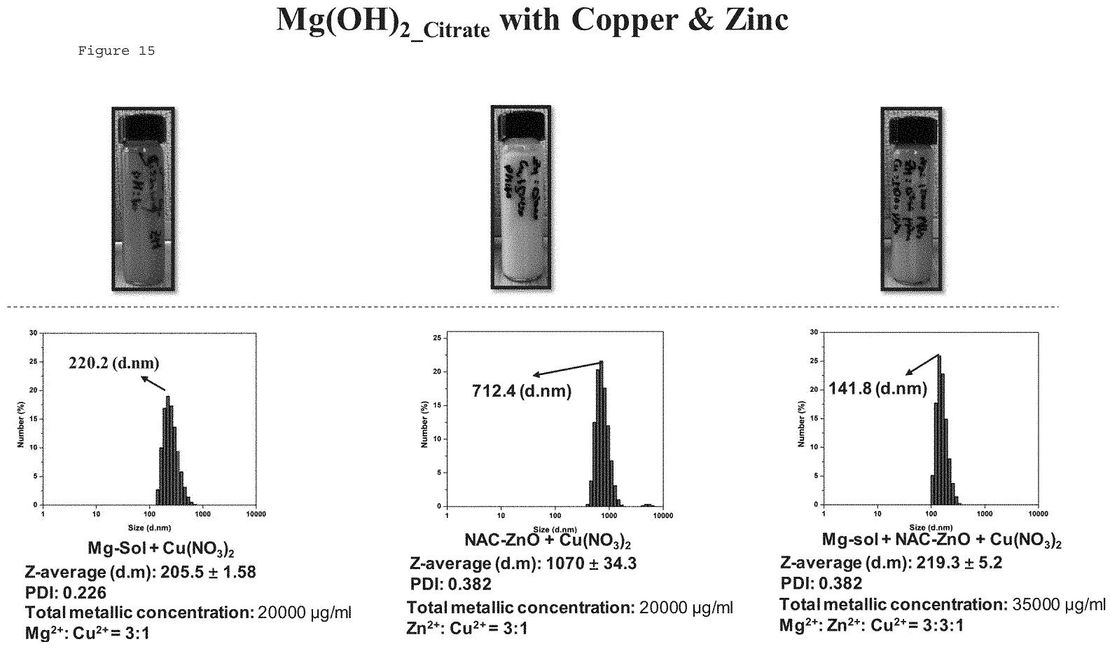

Mg(OH)_{2_Citrate} with H₂O₂ was synthesized following the same protocol for Mg(OH)_{2_Citrate} in Example 1, except for adding H₂O₂ during the synthesis process (molar ratio: Mg²⁺:H₂O₂=1:1). The hydrodynamic size of H₂O₂ added Mg(OH)_{2_Citrate} was around 14 nm (See FIG. 14). Bacteria viability or CFU assay results suggest that H₂O₂ added Mg(OH)_{2_Citrate} exhibit enhanced bacteriostatic & bactericidal efficacy compared to Mg(OH)_{2_Citrate}. The MIC and MBC result for H₂O₂ added Mg(OH)_{2_Citrate} was both 160 ppm of metallic Mg (see Table 5).

2. Mg(OH)_{2_Citrate} with Copper (Cu) and Zinc (Zn)

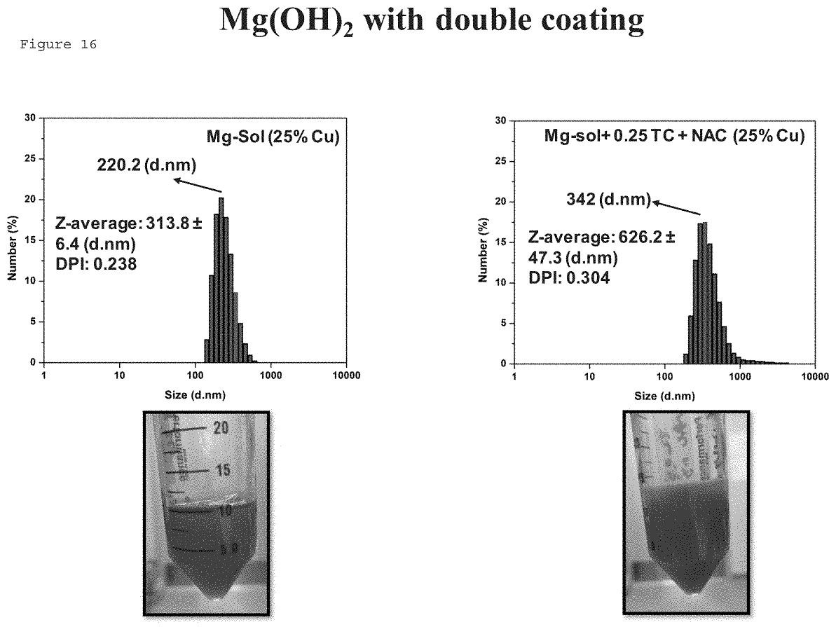

Mg(OH)_{2_Citrate} with H₂O₂ was synthesized following the same protocol for Mg(OH)_{2_Citrate} in Example 1, except for adding Cu or Zn during the synthesis process (molar ratio: Mg²⁺:Zn²⁺:Cu²⁺=3:3:1). The hydrodynamic size of Cu added Mg(OH)_{2_Citrate} was around 220 nm, and the hydrodynamic size of Cu & Zn added was around 142 nm (see FIG. 16). Bacteria viability or CFU assay results suggest that Cu added Mg(OH)_{2_Citrate} exhibit similar bacteriostatic & bactericidal efficacy compared to Mg(OH)_{2_Citrate}. However, Cu added Mg(OH)_{2_Citrate} exhibit higher bactericidal efficacy (80 ppm metallic Cu) when compare with KOCIDE® 3000 (320 ppm metallic Cu). The antimicrobial test result for Zn & Cu added Mg(OH)_{2_Citrate} suggest enhanced bacteriostatic & bactericidal efficacy compared Mg(OH)_{2_Citrate} and KOCIDE® 3000 (see Table 6).

3. Mg(OH)_{2_Citrate} with Double Coating

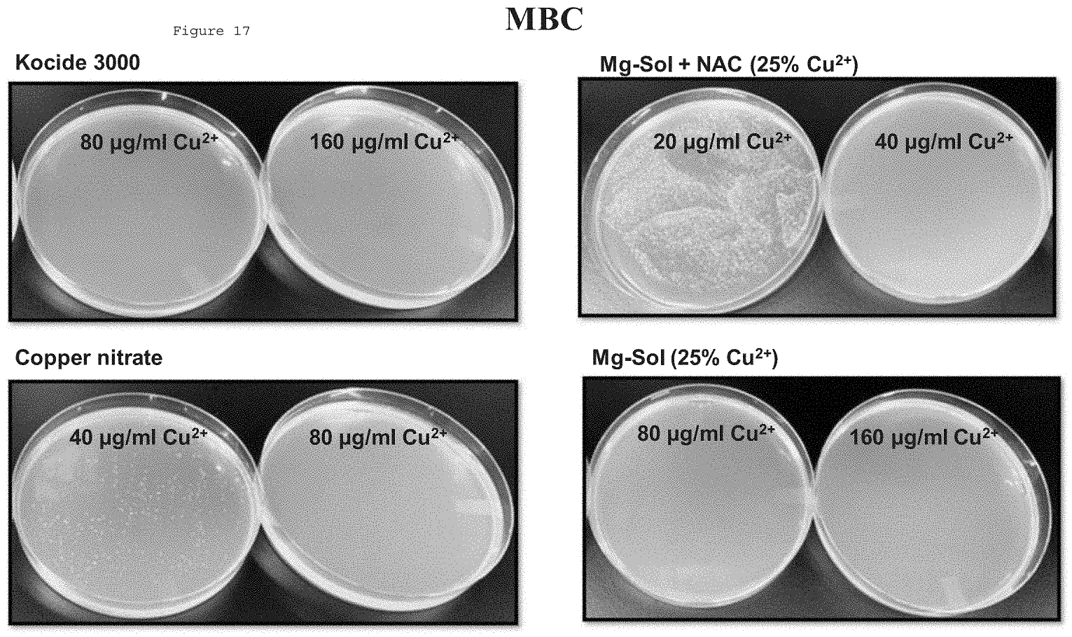

Cu added Mg(OH)₂ with double coating was synthesized following the same protocol for Mg(OH)_{2_Citrate} in Example 1, except for adding Cu and NAC during the synthesis process (molar ratio: Mg²⁺:NAC=1:0.25:0.25, metallic concentration ratio: Mg²⁺ (75%): Cu²⁺ (25%)). The hydrodynamic size of Cu added Mg(OH)₂ double coated was around 342 nm (FIG. 17). Bacteria viability or CFU assay results suggest that Cu added Mg(OH)₂ double coated exhibit enhanced bacteriostatic & bactericidal efficacy compared to Mg(OH)_{2_Citrate}, Cu added Mg(OH)_{2_Citrate} and KOCIDE® 3000. The MIC and MBC result for Cu added Mg(OH)₂ double coated was 60 ppm and 120 ppm of metallic Mg respectively (Table 8).

TABLE 1

| Sample | I₀₀₁ (a.u.) | I₁₀₁ (a.u.) | I₀₀₁/I₁₀₁ |
|---|---|---|---|
| Bulk Mg(OH)₂ | 15705 | 18261 | 0.86 |
| Mg(OH)₂_Betine | 15165 | 7610 | 1.99 |
| Mg(OH)₂_Citrate | 2895 | 1119 | 2.59 |
| Mg(OH)₂_Bare | 10976 | 8053 | 1.36 |

TABLE 2

| Sample | pH | Zeta potential (mV) |
|---|---|---|
| Mg(OH)₂_Betine | 10.7 | +35.3 ± 4.4 |
| Mg(OH)₂_Citrate | 10.6 | −21.8 ± 1.5 |
| Mg(OH)₂_Bare | 11.0 | +28.8 ± 0.8 |

TABLE 3

| | E. coli | P. syringae | X. alfalfa |
|---|---|---|---|
| Sample | (μg/ml) | (μg/ml) | (μg/ml) |
| Mg(OH)₂_Citrate | 1250 | 156 | 313 |
| W-Mg(OH)₂_Citrate | 2500 | 156 | 313 |
| Mg(OH)₂_Betaine | No killing at | 156 | 313 |
| | highest test | | |
| | concentration | | |
| W-Mg(OH)₂_Betaine | No killing at | 156 | 313 |
| | highest test | | |
| | concentration | | |
| Mg(OH)₂_Bare | No killing at | 156 | 313 |
| | highest test | | |
| | concentration | | |
| W-Mg(OH)₂_Bare | No killing at | 156 | 313 |
| | highest test | | |
| | concentration | | |
| KOCIDE 3000 | 313 | 78 | 78 |
| MgCl₂ | No killing at | No killing at | No killing at |
| | highest test | highest test | highest test |
| | concentration | concentration | concentration |
| Betaine | No killing at | No killing at | No killing at |
| | highest test | highest test | highest test |
| | concentration | concentration | concentration |
| Citrate | No killing at | No killing at | No killing at |
| | highest test | highest test | highest test |
| | concentration | concentration | concentration |
| PBS pH:11 | No killing | No killing | No killing |

TABLE 4

| | Metallic concentration | |
|---|---|---|
| Sample | (μg/ml) | I₁₀₁ (a.u.) |
| DI water | NA | − |
| CuSO₄ | 1000 | ++ |
| KOCIDE 3000 | 1000 | − |
| KOCIDE 3000 | 2000 | + |
| Mg(OH)₂_Betine | 1000 | − |
| Mg(OH)₂_Betine | 2000 | + |
| Mg(OH)₂_Citrate | 1000 | + |
| Mg(OH)₂_Citrate | 2000 | + |
| Mg(OH)₂_Bare | 1000 | − |
| Mg(OH)₂_Bare | 2000 | + |

TABLE 5
Testing bacteria: P.syringae

| | Minimum inhibition | | | Minimum bactericidal | | |
|---|---|---|---|---|---|---|
| | concentration | | | concentration | | |
| | (μg/ml) | | | (μg/ml) | | |
| NAME | Mg²⁺ | Zn²⁺ | H₂O₂ | Mg²⁺ | Zn²⁺ | H₂O₂ |
| Mg(OH)₂_{_{—}}_{Citrate} + | 160 | — | 227 | 160 | — | 227 |
| H₂O₂ | | | | | | |
| Mg(OH)₂_{_{—}}_{Citrate} + | 80 | 9 | 126 | 80 | 9 | 126 |
| Zn + H₂O₂ | | | | | | |
| Mg(OH)₂_{_{—}}_{Citrate} | 320 | — | — | 320 | — | — |
| H₂O₂ | — | 20- | 40 | — | — | 80 |

TABLE 6
Testing bacteria: P. syringae

| | Minimum inhibition | | | Minimum bactericidal | | |
|---|---|---|---|---|---|---|
| | concentration | | | concentration | | |
| | (μg/ml) | | | (μg/ml) | | |
| NAME | Mg²⁺ | Zn²⁺ | Cu²⁺ | Mg²⁺ | Zn²⁺ | Cu²⁺ |
| Mg(OH)₂_{_{—}}_{Citrate} + Cu | 320 | — | 80 | 320 | — | 80 |
| (25% Cu²⁺) | | | | | | |
| Cu—Mg—Zn | 120 | 120 | 40 | 240 | 240 | 80 |
| Cu(NO₃)₂ | — | — | 80 | — | — | 160 |
| Kocide 3000 | — | — | 80 | — | — | 320 |
| Mg(OH)₂_{_{—}}_{Citrate} | 320 | — | — | 640 | — | — |
| NAC—ZnO | — | 10 | — | — | 80 | — |

TABLE 7

| Sample | pH | Zeta potential (mV) |
|---|---|---|
| Mg-Sol | 11.15 | −29.03 ± 2 |
| Mg-Sol (25% Cu) | 10.7 | −19.2 ± 3.8 |
| Mg-Sol (25% Cu) + 0.25 TC + 0.25 NAC | 10.6 | −9.7 ± 0.7 |

TABLE 8
Testing bacteria: X. alfalfa

| | Minimum inhibition | | Minimum bactericidal | |
|---|---|---|---|---|
| | concentration | | concentration | |
| | (μg/ml) | | (μg/ml) | |
| NAME | Mg²⁺ | Cu²⁺ | Mg²⁺ | Cu²⁺ |
| Mg-Sol (25% Cu) | 60 | 20 | 480 | 160 |
| Mg-Sol + 0.25 TC + NAC | 60 | 20 | 120 | 40 |
| (25% Cu) | | | | |
| Cu(NO₃)₂ | — | 20 | — | 80 |
| Kocide 3000 | — | 20 | — | 160 |
| Mg-Sol | 320 | — | 320 | — |

### REFERENCES

(1) Charkraborty, S.; Newton, A. C. Climate change, plant diseases and food security: an overview. Plant Pathology. 2011, 60, 2-14.
(2) Martin, R. R.; James, D.; Levesque, C. A. Impacts of molecular diagnostic technologies on plant disease management. Annu. Rev. Phytopathol. 2000, 38, 207-239.
(3) Cha, J. S.; Cooksey, D. A. Copper resistance in Pseudomonas syringae mediated by periplasmic and outer membrane proteins. Proc. Natl. Acad. Sci. 1991, 88, 8915-8919.
(4) Behlau, F.; Canteros, B. I.; Minsavage, G. V.; Jones, J. B.; Graham, J. H. Molecular Characterization of Copper Resistance Genes from Xanthomonas citri subsp. citri and Xanthomonas alfalfae subsp. citrumelonis. Appl. Environ. Microbiol. 2001, 77, 4089-4096.
(5) Behlau, F.; Belasque, J., Jr.; Graham, J. H.; Leite, R. P., Jr. Effect of frequency of copper applications on control of citrus canker and the yield of young bearing sweet orange trees. Crop Prot. 2010, 29, 300-305.
(6) Behlau, F.; Belasque, J., Jr.; Bergamin Filho, A.; Graham, J. H.; Leite, R. P., Jr.; Gottwald, T. R. Copper sprays and windbreaks for control of citrus canker on young orange trees in southern Brazil. Crop Prot. 2008, 27, 807-813.
(7) Roy, A. S.; Parveen, A.; Koppalkar, A. R.; Prasad, M. Effect of Nano-Titanium Dioxide with Different Antibiotics against Methicillin-Resistant Staphylococcus Aureus. J. Biomater. Nanobiotechnol. 2010, 1, 37-41.
(8) Jeong, M. S.; Park, J. S.; Song, S. H.; Jang, S. B. Characterization of Antibacterial Nanoparticles from the Scallop, Ptinopecten yessoensis. Biosci. Biotechnol. Biochem. 2007, 71, 2242-2247.
(9) Leung, Y. H.; Ng, A. M. C.; Xu, X. Y.; Shen, Z. Y.; Gethings, L. A.; Wong, M. T.; Chan, C. M. N.; Guo, M. Y.; Ng, Y. H.; Djurisic, A. B. Mechanisms of Antibacterial Activity of MgO: Non-ROS Mediated Toxicity of MgO Nanoparticles Towards Escherichia coli. Small. 2014, 10, 1171-1183.
(10) Mahapatra, O.; Bhagat, M.; Gopalakrishnan, C.; Arunachalam, K. D. Ultrafine dispersed CuO nanoparticles and their antibacterial activity. J. Exp. Nanosci. 2008, 3, 185-193.
(11) Padmavathy, N.; Vijayaraghavan, R. Enhanced bioactivity of ZnO nanoparticles—an antimicrobial study. Sci. Technol. Adv. Mater. 2008, 9, 1-7.
(12) Gogos, A.; Knauer, K.; Bucheli, T. D. Nanomaterials in plant protection and fertilization: current state, foreseen application, and research priorities. J. Agric. Food Chem. 2012, 60, 9781-9792.
(13) Young, M.; Ozcan, A.; Myers, M. E.; Johnson, E. G.; Graham, J. H.; Santra, S. Multimodal Generally Recognized as Safe ZnO/Nanocopper Composite: A Novel Antimicrobial Material for the Management of Citrus Phytopathogens. J. Agric. Food Chem. 2017 (DOI: 10.1021/acs.jafc.7b02526).
(14) Young, M.; Santra, S. Copper (Cu)-Silica nanocomposite containing valence-engineered Cu: A new strategy for improving the antimicrobial efficacy of Cu biocides. J. Agric. Food Chem. 2014, 62, 6043-6052.
(15) Jiao, C, M.; Wang, Z. Z.; Ye, Z.; Hu, Y.; Fan, W. C. Flame Retardation of Ethylene-Vinyl Acetate Copolymer Using Nano Magnesium Hydroxide and Nano Hydrotalcite. J. Fire. Sci. 2006, 24, 47-64.
(16) Booster, J. L.; Van, S. A.; Reuter, M. A. Conversion of magnesium fluoride to magnesium hydroxide. Minerals Engineering. 2003, 16, 273-281.
(17) Kang, J. C.; Schwendeman, S. P. Comparison of the effects of Mg(OH)₂ and sucrose on the stability of bovine serum albumin encapsulated in injectable poly (D, L-lactide-co-glycolide) implants. Biomaterials. 2002, 23, 239-245.
(18) Li, L. G.; Sokolov, L. N.; Yang, Y. H.; Li, D. P.; Ting, J.; Pandy, G. K.; Luan, S. A Mitochondrial Magnesium Transporter Functions in Arabidopsis Pollen Development. Molecular Plant. 2008, 1, 675-685.
(19) Cakmak, I.; Kirkby, E. A. Role of magnesium in carbon partitioning and alleviating photooxidative damage. Physiologia Plantarum. 2008, 133, 692-704.
(20) Pan, X. H.; Wang, Y. H.; Chen, Z.; Pan, D. M.; Cheng, Y. J.; Liu, Z. J.; Lin, Z.; Guan, X. Investigation of antibacterial activity and related mechanism of a series of Nano-Mg(OH)₂. ACS Appl. Mater. Interfaces. 2013, 5, 1137-1142.
(21) Dong, C. X.; Song, D. L.; Cairney, J.; Maddan, O. L.; Maddan, O. L.; He, G. H.; Deng, Y. L. Antibacterial study of Mg(OH)₂ nanoplatelets. Mater Res Bull. 2011, 46, 576-582.
(22) Laska, M.; Valtyni, J.; Fellner, P. Influence of pH on the crystal size distribution of Mg(OH)₂ prepared by the hydration of MgO. Crystal Research and Technology. 1993, 28, 931-936.
(23) Hsu, J. P.; Nacu, A. Preparation of submicron-sized Mg(OH)₂ particles through precipitation. Colloids and surfaces A: Physicochem. Eng. Aspects. 2005, 262, 220-231.
(24) Zou, G. L.; Chen, W. X.; Liu, R.; Xu, Z. D. Morphology-tunable synthesis and characterization of Mg(OH)₂ films via a cathodic electrochemical process. Materials Chemistry and Physics. 2008, 107, 85-90.
(25) Henrist, C.; Mathieu, J. P.; Vogels, C.; Rulmont, A.; Cloots, R. Morphological study of magnesium hydroxide nanoparticles precipitated in dilute aqueous solution. J. Cryst. Growth. 2003, 249, 321-330.
(26) Rajasekaran, P.; Santra, S. Hydrothermally treated chitosan hydrogel loaded with copper and zinc particles as a potential micronutrient-based antimicrobial feed additive. Front. Vet. Sci. 2015, 2, 1-9.
(27) Lin, D. H.; Xing, B. S. Phytotoxicity of nanoparticles: inhibition of seed germination and root growth. Environmental Pollution. 2007, 150, 243-250.
(28) Yang, L.; Watts, D. J. Particle surface characteristics may play an important role in phytotoxicity of alumina nanoparticles. Toxicol. Lett. 2005, 158, 122-132.
(29) Das, S.; Wolfson, B. P.; Tetard, L.; Tharkur, J.; Bazata, J.; Santra, S. Effect of N-acetyl cysteine coated CdS: Mn/ZnS quantum dots on seed germination and seedling growth of snow pea (Pisum sativul L.): imaging and spectroscopic studies. Environ. Sci. Nano. 2015, 2, 203-212.
(30) Klug, H. P.; Alexander, L. E. X-ray Diffraction Procedures. Wiley, New York, 1962.
(31) Chen, Y. B.; Zhou, T.; Fang, H. X.; Li, S. M.; Yao, Y. T.; He, Y. A novel preparation of nano-sized hexagonal Mg(OH)₂. Procedia Engineering. 2015, 102, 388-394.
(32) Kumari, L.; Li, W. Z.; Vannoy, C. H.; Leblanc, R. M.; Wang, D. Z. Synthesis, characterization and optical properties of Mg(OH)₂ micro-/nanostructure and its conversion to MgO. Ceramics International. 2009, 35, 3355-3364.
(33) Sato, H.; Morita, A.; Ono, K.; Nakano, H.; Wakabayashi, N.; Yamagishi, A. Templating effects on the mineralization of layered inorganic compounds: (1) density functional calculations of the formation of single-layered magnesium hydroxide as a brucite model. Langmuir. 2003, 19, 7120-7126.
(34) Phillips, V. A.; Kolbe, J. L.; Opperhauser, H. Effect on pH on the growth of Mg(OH)₂ crystals in an aqueous environment at 60° C. J. Crystal Growth. 1977, 41, 228-234.
(35) Lv, J. P.; Qiu, L. Z.; Qu, B. J. Controlled growth of three morphological structures of magnesium hydroxide nanoparticles by wet precipitation method. J. Cryst. Growth. 2004, 267, 676-684.
(36) Yang, Z. Z.; Chen, J.; Dou, R. Z.; Gao, X.; Mao, C. B.; Wang, L. Assessment of the Phytotoxicity of Metal Oxide Nanoparticles on Two Crop Plants, Maize (Zea mays L.) and Rice (Oryza sativa L.). Int. J. Environ. Res. Public Health. 2015, 12, 15100-15109.
(37) Lee, C. W.; Mahendra, S.; Zodrow, K.; Li, D.; Tsai, Y. C.; Braam, J.; Alvarez, P. J. J. Developmental phytotoxicity of metal oxide nanoparticles to Arabidopsis thaliana. Environ. Toxicol. Chem. 2010, 29, 1399-1399.
(38) Nair, R.; Varghese, S. H.; Nair, B. G.; Maekawa, T.; Yoshida, Y.; Kumar, D. S. Nanoparticulate material delivery to plants. Plant Science. 2010, 179, 154-163.
   All patents, patent applications, patent publications, technical publications, scientific publications, and other references referenced herein are hereby incorporated by reference in this application to the extent they are not inconsistent with the teachings herein. In particular, the following references are hereby incorporated by reference in their entirety.

1. A composition comprising magnesium hydroxide nanoparticles coated with a water-soluble capping agent.

2. The composition of claim 1, wherein the water-soluble capping agent is trisodium citrate, choline or betaine, or a combination thereof.

3. The composition of claim 1 wherein the average particle size of the magnesium hydroxide nanoparticles is from about 1 to about 250 nm.

4. The composition of claim 2, wherein nanoparticles coated with trisodium citrate have a negative zeta potential.

5. The composition of claim 4, wherein the zeta potential ranges from −15 to −25 mV.

6. The composition of claim 2, wherein the nanoparticles coated with betaine have a positive zeta potential.

7. The composition of claim 6, wherein the zeta potential ranges from about +30 to +40 mV.

8. The composition of claim 1, wherein the capping agent is citrate and the nanoparticles are synthesized in the presence of hydrogen peroxide.

9. The composition of claim 8, wherein the nanoparticles are synthesized in the further presence of copper, zinc or N-Acetyl Cysteine (NAC) or a combination thereof.

10. A method of killing a plant pathogen comprising administering to the plant pathogen an effective amount of a composition as set forth in claim 1.

11. The method of claim 10, wherein the effective amount is one that can kill the plant pathogen without causing more than slight leaf damage.

12. The method of claim 10, wherein the plant pathogen is infecting a plant.

13. A method of treating a plant infected with a plant pathogen, or protecting a plant from infection by a plant pathogen, comprising administering to the plant an effective amount of a composition as set forth in claim 1.

14. The method of claim 13, wherein the effective amount is one that can kill the plant pathogen or reduce amount of plant pathogen without causing more than slight leaf damage.

15. The method of claim 10, wherein the plant comprises fruit, vegetable, grass, legumes, cotton, tobacco, nut, herb, spice, or ornamental plants.

16. The method of claim 15, wherein the plant comprises hazelnut, pecan, citrus, walnut, onion, strawberry or pepper plants.

17. A composition comprising magnesium hydroxide nanoparticles coated with a water-soluble positively charged capping agent and a negatively charged capping agent.

18. The composition of claim 17, wherein the positive charged capping agent comprises betaine or choline or a combination thereof.

19. The composition of claim 17, wherein the negative charged capping agent comprises NAC, citrate, gluconate, or salicylate, or a combination of at least two thereof.

20. Nanoparticles made by a process comprising:
Co-precipitating MgCl₂ in the presence of at least one positively charged capping agent and/or at least one negatively charged capping agent, in deionized water.

21. (canceled)

22. (canceled)

23. (canceled)

24. (canceled)

25. (canceled)
